(19) United States
(12) Patent Application Publication
(10) Pub. No.: US 2009/0135102 A1
(43) Pub. Date: May 28, 2009

(54) ORGANIC LIGHT EMITTING DEVICE

(75) Inventor: Hongki Park, Gumi-city (KR)

Correspondence Address: KED & ASSOCIATES, LLP, P.O. Box 221200, Chantilly, VA, 20153-1200, US

(73) Assignee: LG Electronics Inc.

(21) Appl. No.: 11/950,018

(22) Filed: Dec. 4, 2007

(30) Foreign Application Priority Data
Nov. 27, 2007 (KR) 10-2007-0121521

(51) Int. Cl. G09G 3/30

(52) U.S. Cl. 345/76

(57) ABSTRACT

An organic light emitting device includes a substrate having a plurality of pixels, with each pixel comprising a plurality of sub-pixels. Each sub-pixel includes an emission area, the emission area including a first electrode, a second electrode and an emitting layer. Scan, data, and power supply lines are provided to supply scan, data, and power signals to one or more corresponding sub-pixels. Additionally, a ratio of a distance between adjacent sub-pixels to a width of the power supply line lies in a predetermined range.

This application claims priority from Korean Patent Application Nos. 10-2007-0121521, filed Nov. 27, 2007, the subject matters of which are incorporated herein by reference.

### BACKGROUND

1. Field

One or more embodiments described herein relate to a display device.

2. Background

The importance of flat panel displays has increased with consumer demand for multimedia products and services. One type of flat panel display known as an organic light emitting device (OLED) has proven to be desirable because of its rapid response time, low power consumption, self-emission structure, and wide viewing angle. In spite of these advantages, OLEDs are unreliable because of their inability to maintain uniform luminance characteristics.

### BRIEF DESCRIPTION OF THE DRAWINGS

FIG. 1 is a diagram showing one embodiment of an organic light emitting device.

FIG. 2 is a cross-sectional view taken along a line I-I′ of FIG. 1.

FIG. 3 is a diagram showing another embodiment of an organic light emitting device.

FIG. 4 is a graph showing a relationship between differences in luminance that exist for various ratios of unit pixel distance to power supply line width in accordance with one or more of the foregoing embodiments.

FIGS. 5A to 5C are diagrams showing various implementations of a color image display method in an organic light emitting device according to one or more exemplary embodiments.

### DETAILED DESCRIPTION

Generally, there are two types of organic light emitting devices: passive-matrix OLEDs and active-matrix OLEDs. In a passive matrix OLED, an anode electrode is situated at right angles to a cathode electrode, and the device is driven by a line-selection scheme. In an active matrix OLED, a thin film transistor is connected to each sub-pixel electrode, and the device is driven based on the capacitance of a capacitor connected to a gate electrode of the thin film transistor.

In an active matrix OLED, scan and data signals are supplied to each sub-pixel through respective scan and data lines, and electrical power is supplied from a power supply line. The sub-pixel then emits light based on these signals. However, because the scan, data, and power supply lines are made of a metal having electrical resistance characteristics, the signals supplied to a sub-pixel positioned far away from a supply source of the signals are distorted, because of the resistance associated with the lines. As a result, the luminance of the OLED is not uniform, thereby making the device unreliable.

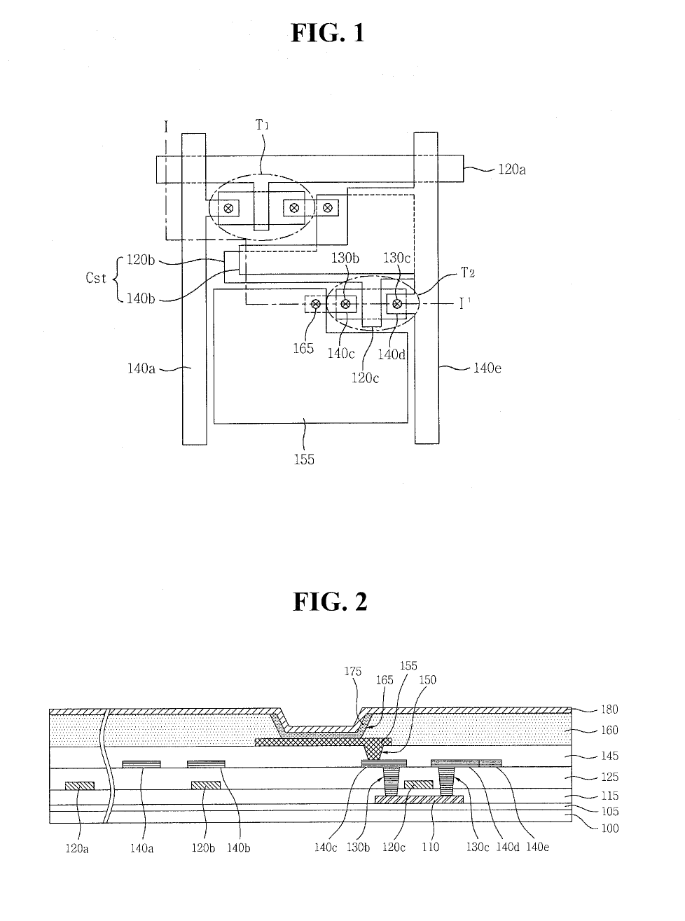

FIG. 1 shows the structure corresponding to one embodiment of a sub-pixel of an organic light emitting device. This structure includes a substrate 100 having a sub-pixel area and a non-sub-pixel area positioned outside the sub-pixel area. The sub-pixel area lies with boundaries defined by a scan line 120a positioned in one direction, a data line 140a perpendicular to the scan line 120a, and a power supply line 140e parallel to the data line 140a.

The sub-pixel area further includes a switching thin film transistor T1 connected to the scan line and data line, a capacitor Cst connected to the switching thin film transistor T1 and the power supply line 140e, and a driving thin film transistor T2 connected to the capacitor Cst and the power supply line. The capacitor Cst may be formed from a capacitor lower electrode 120b and a capacitor upper electrode 140a.

The sub-pixel area further includes an organic light emitting diode having a first electrode 155 electrically connected to the driving thin film transistor T2, an organic layer (not shown) including at least an emitting layer on the first electrode, and a second electrode (not shown). The scan line 120a, data line 140a, and power supply line 140e are positioned in the non-sub-pixel area.

FIG. 2 is a cross-sectional view taken along a line I-I′ in FIG. 1. As shown in this view, a buffer layer 105 is positioned on the substrate. The buffer layer serves to protect the thin film transistor(s) from impurities such as alkali ions discharged from the substrate in a succeeding process. The buffer layer may be selectively formed from silicon oxide (SiO₂), silicon nitride (SiN_{X}), or another material and the substrate may be formed of glass, plastic, or metal.

A semiconductor layer 110 is positioned on the buffer layer and may be made from amorphous silicon or crystallized poly-silicon. The semiconductor layer may include source and drain areas containing p-type or n-type impurities, as well as a channel area.

A first insulating layer 115, which may be a gate insulating layer, is positioned on the semiconductor layer and may be made from a silicon oxide (SiO₂) layer, a silicon nitride (SiN_{X}) layer, or a multi-layer structure including a combination thereof.

A gate electrode 120c is positioned on the first insulating layer in a given area of the semiconductor layer (e.g., in a location corresponding to the channel area of semiconductor layer 110 when impurities are doped). The scan line 120a and capacitor lower electrode 120b may be positioned on the same formation layer as the gate electrode 120c.

The gate electrode may have a single-layer structure made of molybdenum (Mo), aluminum (Al), chromium (Cr), gold (Au), titanium (Ti), nickel (Ni), neodymium (Nd), or copper (Cu) or a combination thereof. Alternatively, the gate electrode 120c may have a multi-layer structure made of Mo, Al, Cr, Au, Ti, Ni, Nd, or Cu or a combination thereof. According to one particular embodiment, gate electrode 120c has a double-layer structure including Mo/Al—Nd. Other materials may also be used if desired.

The scan line 120a may have a single-layer structure made of Mo, Al, Cr, Au, Ti, Ni, Nd, or Cu or a combination thereof. Alternatively, the scan line may have a multi-layer structure made of Mo, Al, Cr, Au, Ti, Ni, Nd, or Cu or a combination thereof. According to one particular embodiment, the scan line has a double-layer structure including Mo/Al—Nd. Other materials may be used if desired.

Structurally, the scan line has a predetermined width, for example, equal to or more than 3 μm and less than 5 μm and a predetermined thickness, for example, equal to or more than 300 nm and less than 450 nm. The scan line supplies a scan signal to each sub-pixel; that is, a scan driver positioned outside the sub-pixel area supplies a scan signal to each sub-pixel through the scan line.

Because scan line 120a is a metal conductive line having electrical resistance characteristics, a value of a scan signal supplied to a sub-pixel near the scan driver may be different from a value of a scan signal supplied to a sub-pixel far away from the scan driver. More specifically, since the scan driver supplies a scan signal to each sub-pixel through the scan line 120a, the scan signal of each sub-pixel may have a different value due to a resistance of the scan line. As a result, a voltage drop (IR-drop) may be caused by the resistance of the scan line. In accordance with one embodiment, a thickness and/or width of the scan line is adjusted to reduce the resistance of the scan line, and thus to prevent or reduce the chances of a voltage drop from occurring.

According to one embodiment, the scan line may have a width equal to or more than 3 μm and less than 5 μm and a thickness equal to or more than 300 nm and less than 450 nm. When the width of the scan line is equal to or more than 3 μm, the resistance of the scan line is reduced or minimized and thus voltage drop can be prevented. Hence, non-uniformity of the luminance of the organic light emitting device can be prevented. When the width of the scan line 120a is less than 5 μm, pixel shrinkage can be prevented due to an increase in the width of the scan line.

When the thickness of the scan line is equal to or more than 300 nm, the resistance of the scan line is reduced or minimized and voltage drop can be prevented. Hence, non-uniformity of the luminance of the device can be prevented. When the thickness of the scan line is less than 450 nm, step coverage of layers such as an insulating layer to be formed later can be reduced. Hence, exposure of the scan line can be prevented, and thus short between the scan line and another conductive line can be prevented.

A second insulating layer 125, serving as an interlayer dielectric, may be positioned on the substrate on which scan line 120a, capacitor lower electrode 120b, and gate electrode 120c are positioned. The second insulating layer may be made of silicon oxide (SiO₂) layer, a silicon nitride (SiN_{X}) layer, or a multi-layer structure may include a combination thereof.

Contact holes 130b and 130c may be positioned inside second insulating layer 125 and first insulating layer 115 to expose a portion of semiconductor layer 120.

A drain electrode 140c and source electrode 140d are positioned in the sub-pixel area and are electrically connected to semiconductor layer 120 through contact holes 130b and 130c passing through second insulating layer 125 and first insulating layer 115.

The drain electrode 140c and source electrode 140d may have a single-layer structure or a multi-layer structure. When the drain and source electrodes have a single-layer structure, they may be made of Mo, Al, Cr, Au, Ti, Ni, Nd, or Cu, or a combination thereof. Other materials maybe used if desired.

When the drain and source electrodes have a multi-layer structure, they may have a double-layer structure that includes Mo/Al—Nd, Mo/Al or Ti/Al or a triple-layer structure including Mo/Al/Mo, Mo/Al—Nd/Mo or Ti/Al/Ti.

The data line 140a, capacitor upper electrode 140b, and power supply line 140e are preferably positioned on the same formation layer as the drain electrode 140c and source electrode 140d.

The data line 140a and power supply line 140e are positioned in the non-sub-pixel area and may have a single-layer structure or a multi-layer structure. When the data line and power supply line have a single-layer structure, they may be made of Mo, Al, Cr, Au, Ti, Ni, Nd, or Cu or a combination thereof. Other materials may be used if desired.

When the data and power supply lines have a multi-layer structure, they may have a double-layer structure that includes Mo/Al—Nd, Mo/Al, or Ti/Al or a triple-layer structure that includes Mo/Al/Mo, Mo/Al—Nd/Mo or Ti/Al/Ti. In one particular embodiment, the data and power supply lines have a triple-layer structure that includes Mo/Al—Nd/Mo.

According to one embodiment, the data line 140a has a width of 3to 5 μm and a thickness of 450 to 600 nm. The data line supplies a data signal to one or more sub-pixels, e.g., a data driver positioned outside the sub-pixel area supplies a data signal to one or more sub-pixels.

Because data line 140a is a metal conductive line having electrical resistance characteristics, a value of a data signal supplied to a sub-pixel near the data driver may be different from a value of a data signal supplied to a sub-pixel positioned far away from the data driver. More specifically, since the data driver supplies a data signal to each sub-pixel through the data line 140a, the data signal of each sub-pixel may have a different value due to a resistance of the data line 140a. As a result, a voltage drop (IR-drop) may be caused by resistance of the data line. According to one embodiment, the thickness and/or width of the data line is adjusted to reduce the resistance of the data line and thus voltage drop can be prevented.

According to one particular embodiment, data line 140a may have a width of 3 to 5 μm and a thickness of 450 to 600 nm. When the width of the data line is equal to or more than 3 μm, the resistance of the data line is reduced or minimized and thus voltage drop can also be prevented. And, when the width of the data line is equal to or less than 5 μm, pixel shrinkage can be prevented due to an increase in the width of the data line.

When the thickness of the data line is equal to or more than 450 nm, the resistance of the data line is reduced or minimized and thus voltage drop can be prevented. When the thickness of the data line is equal to or less than 600 nm, step coverage of layers such as an insulating layer to be formed later can be reduced. Hence, exposure of the data line can be prevented and thus the chances of a short forming between the data line and another conductive line can be reduced.

The power supply line 140e is used to supply electrical power to one or more corresponding sub-pixels, and may have a width of 5 to 7 μm and a thickness of 450 to 600 nm.

Because the power supply line 140e is a metal conductive line having electrical resistance characteristics, electrical power supplied to a sub-pixel near a power supply unit (not shown) may be different from electrical power supplied to a sub-pixel far away from the power supply unit. More specifically, since the power supply unit supplies electrical power to one or more sub-pixels through the power supply line 140e, the electrical power of each sub-pixel may have a different value due to a resistance of the power supply line. As a result, a voltage drop (IR-drop) may be caused by the resistance of the power supply line. According to one embodiment, a thickness and/or width of the power supply line may be adjusted to reduce the resistance of the power supply line and thus the voltage drop can be prevented.

According to one particular embodiment, power supply line 140e may have a width of 5 to 7 μm and a thickness of 450 to 600 nm. When the width of the power supply line is equal to or more than 5 μm, the resistance of the power supply line is reduced or minimized and thus non-uniformity in luminance of the device caused by voltage drop can be prevented. And, when the width of the power supply line is equal to or less than 7 μm, pixel shrinkage can be prevented due to an increase in the width of the power supply line.

When the thickness of the power supply line is equal to or more than 450 nm, the resistance of the power supply line is reduced or minimized and thus non-uniformity in luminance of the device caused by voltage drop can be prevented. When the thickness of power supply line 140e is equal to or less than 600 nm, step coverage of layers such as an insulating layer to be formed later can be reduced. Hence, exposure of the power supply line can be prevented, which reduces the chances of a short forming between the power supply line and another conductive line.

According to one embodiment, when the data line 140a and the power supply line 140e have a triple-layer structure including Mo/Al—Nd/Mo, a thickness of a first layer may range from 40 to 60 nm, a thickness of a second layer may range from 400 to 500 nm, and a thickness of a third layer may range from 10 to 30 nm.

In the triple-layer structure, a Mo layer forming the first layer serves as an ohmic contact to reduce a resistance between the Mo layer and another layer, and a thickness of the Mo layer may range from 40 to 60 nm. An Al—Nd layer forming the second layer has a low resistance and reduces the resistances of the lines, and a thickness of the Al or Al—Nd layer may range from 400 to 500 nm. A Mo layer forming the third layer servers as a protective layer for avoiding an Al—Nd hillock phenomenon, in which Al—Nd rises at a high temperature, in a succeeding thermal process. A thickness of the Mo layer may range from 10 to 30 nm.

Thus, as noted above, the width and thickness of each line 120a, 140a and 140e can be adjusted to reduce the resistances of those lines. Furthermore, the dimensions of the lines may also be set to achieve a resistance of one line relative to one or more of the remaining lines.

That is, a resistance of data line 140a may be lower than a resistance of scan line 120a. More specifically, the thickness of the data line 140a may be larger than the thickness of scan line 120a, and the width of data line 140a may be larger than the width of scan line 120a. Hence, a cross-sectional area of the data line determined by thickness and width may be larger than a cross-sectional area of the scan line.

The data line 140a and scan line 120a may respectively send a data signal and a scan signal to one or more sub-pixels. Since a supply frequency of the data signal may be higher than a supply frequency of the scan signal, the data signal is sensitive to the line resistance. Hence, distortion of the data signal may be larger than the distortion of the scan signal.

Accordingly, the resistance of data line 140a can be lower than the resistance of the scan line 120a by setting the cross-sectional area of the data line to be larger than the cross-sectional area of the scan line.

Also, a resistance of power supply line 140e may be lower than a resistance of data line 140a. More specifically, the width of the power supply line may be larger than the width of the data line. Hence, a cross-sectional area of the power supply line may be larger than a cross-sectional area of the data line.

While data line 140a sends the data signal to one or more sub-pixels, current does not flow into the data line in a normal state. Therefore, influence of voltage drop on data line 140a may be less than influence of the voltage drop on the power supply line 140e. However, since the power supply line is directly connected to the organic light emitting diode including the first electrode 155, the emitting layer, and the second electrode, voltage drop of the power supply line 140e directly affects non-uniformity of the luminance of the device. Accordingly, the power supply line is very sensitive to the resistance.

Accordingly, the resistance of power supply line 140e can be lower than the resistance of data line 140a by setting the cross-sectional area of the power supply line to be larger than the cross-sectional area of the data line.

In an exemplary embodiment, the thicknesses of data line 140a and power supply line 140e may be larger than the thickness of scan line 120a. While the scan line supplies a scan signal for performing On/Off operations of switching thin film transistor T1, data line 140a and power supply line 140e supply a data signal and electrical power to the driving thin film transistor T2 for driving the organic light emitting diode, respectively. In other words, because the data signal and electrical power directly affect light emission luminance, the data signal and electrical power are more sensitive than the scan signal to the line resistance.

Accordingly, voltage drop caused by line resistance can be prevented by setting the thicknesses of data line 140a and power supply line 140e to be larger than the thickness of the scan line 120a.

A third insulating layer 145 is positioned on data line 140a, capacitor upper electrode 104b, drain electrode 140c, source electrode 140d, and power supply line 140e. The third insulating layer may be a planarization layer for obviating a height difference of a lower structure. The third insulating layer may be formed of an organic material such as polyimide, benzocyclobutene-based resin and acrylate or an inorganic material such as spin on glass (SOG) obtained by spin-coating silicone oxide (SiO₂) in the liquid form and solidifying it. Otherwise, third insulating layer 145 may be a passivation layer, and may include a silicon oxide (SiO₂) layer, a silicon nitride (SiN_{X}) layer, or a multi-layered structure including a combination thereof.

A via hole 150 is positioned inside third insulating layer 145 to expose one of the source or drain electrodes 140c and 140d. The first electrode 155 is positioned on the third insulating layer to be electrically connected to one of the source or drain electrodes 140c and 140d through the via hole.

The first electrode 155 may, for example, be an anode electrode. When the organic light emitting device has a bottom-emission or dual-emission structure, the first electrode may be a transparent electrode formed of one of indium-tin-oxide (ITO), indium-zinc-oxide (IZO), or zinc oxide (ZnO). When the organic light emitting device has a top-emission structure, the first electrode may be a reflection electrode. In this case, a reflection layer formed of one of Al, Ag, or Ni may be positioned under a layer formed of one of ITO, IZO, or ZnO, and also a reflection layer formed of one of Al, Ag, or Ni may be positioned between two layers formed of one of ITO, IZO, or ZnO.

A fourth insulating layer 160 including an opening 165 is positioned on the first electrode 155. The opening provides electrical insulation between the neighboring first electrodes and exposes a portion of the first electrode. The fourth insulating layer may be a bank layer or a pixel definition layer. An organic layer 175 may be positioned on the first electrode exposed by opening 165.

The organic layer 175 includes at least an emitting layer. According to one embodiment, the organic layer 175 may further include an electron injection layer, an electron transporting layer, a hole transporting layer or a hole injection layer on or under the emitting layer.

At least one layer forming the organic layer may further include an inorganic material, and the inorganic material may include a metal compound such as, for example, an alkali metal or alkaline earth metal. According to one embodiment, the inorganic material includes LiF, NaF, KF, RbF, CsF, FrF, BeF2, MgF2, CaF2, SrF2, BaF2, or RaF2.

At least one layer forming organic layer 175 may include an organic material and an inorganic material. The inorganic material may be one having a highest occupied molecular orbital, in order to reduce a lowest unoccupied molecular orbital of the organic material. In particular, LiF forms a strong dipole and improves the electron injection into the emitting layer, which thereby improves the light emission efficiency and reduces driving voltage.

In operation, the at least one layer forming organic layer 175 including the inorganic material facilitates hopping of electrons injected into the emitting layer from the second electrode, and adjusts a balance of holes and electrons injected into the emitting layer, thereby improving light emission efficiency.

The emitting layer may be formed of a material capable of emitting red, green, or blue light, and may be formed using a phosphorescence material or a fluorescence material.

In the case where emitting layer 175 emits red light, the emitting layer may include a host material including carbazole biphenyl (CBP) or 1,3-bis(carbazol-9-yl (mCP), and may be formed of a phosphorescence material including a dopant material including but not limited to any one selected from the group consisting of PIQIr(acac)(bis(1-phenylisoquinoline)acetylacetonate iridium), PQIr(acac)(bis(1-phenylquinoline)acetylacetonate iridium), PQIr(tris(1-phenylquinoline)iridium) or PtOEP(octaethylporphyrin platinum) or a fluorescence material including PBD:Eu(DBM)3(Phen) or Perylene. However, other materials may be used to form emitting layer 175 that emits red light.

In the case where the emitting layer emits red light, a highest occupied molecular orbital of the host material may range from 5.0 to 6.5, and a lowest unoccupied molecular orbital of the host material may range from 2.0 to 3.5. A highest occupied molecular orbital of the dopant material may range from 4.0 to 6.0, and a lowest unoccupied molecular orbital of the dopant material may range from 2.4 to 3.5.

In the case where the emit layer emits green light, the emitting layer may include a host material including CBP or mCP, and may be formed of a phosphorescence material including a dopant material that contains Ir(ppy)3(factris(2-phenylpyridine)iridium) or a fluorescence material including Alq3(tris(8-hydroxyquinolino)aluminum). Other materials may also be used to form an emitting layer that emits green light.

In the case where the emitting layer emits green light, a highest occupied molecular orbital of the host material may range from 5.0 to 6.5, and a lowest unoccupied molecular orbital of the host material may range from 2.0 to 3.5. A highest occupied molecular orbital of the dopant material may range from 4.5 to 6.0, and a lowest unoccupied molecular orbital of the dopant material may range from 2.0 to 3.5.

In the case where the emitting layer emits blue light, the emitting layer may include a host material that includes CBP or mCP and may be formed of a phosphorescence material including a dopant material that includes (4,6-F2ppy)2Irpic or a fluorescence material including any one selected from the group consisting of spiro-DPVBi, spiro-6P, distyryl-benzene (DSB), distyryl-arylene (DSA), PFO-based polymers, PPV-based polymers or a combination thereof. Other materials may also be used to form an emitting layer that emits blue light.

In the case where the emitting layer emits blue light, a highest occupied molecular orbital of the host material may range from 5.0 to 6.5, and a lowest unoccupied molecular orbital of the host material may range from 2.0 to 3.5. A highest occupied molecular orbital of the dopant material may range from 4.5 to 6.0, and a lowest unoccupied molecular orbital of the dopant material may range from 2.0 to 3.5.

A second electrode 180 is positioned on organic layer 175. The second electrode may be a cathode electrode made of Mg, Ca, Al, or Ag having a low work function or a combination thereof. When the organic light emitting device has a top-emission or dual-emission structure, the second electrode may be thin to allow the second electrode to transmit light. When the organic light emitting device has a bottom-emission structure, the second electrode may be thick to allow the second electrode to reflect light.

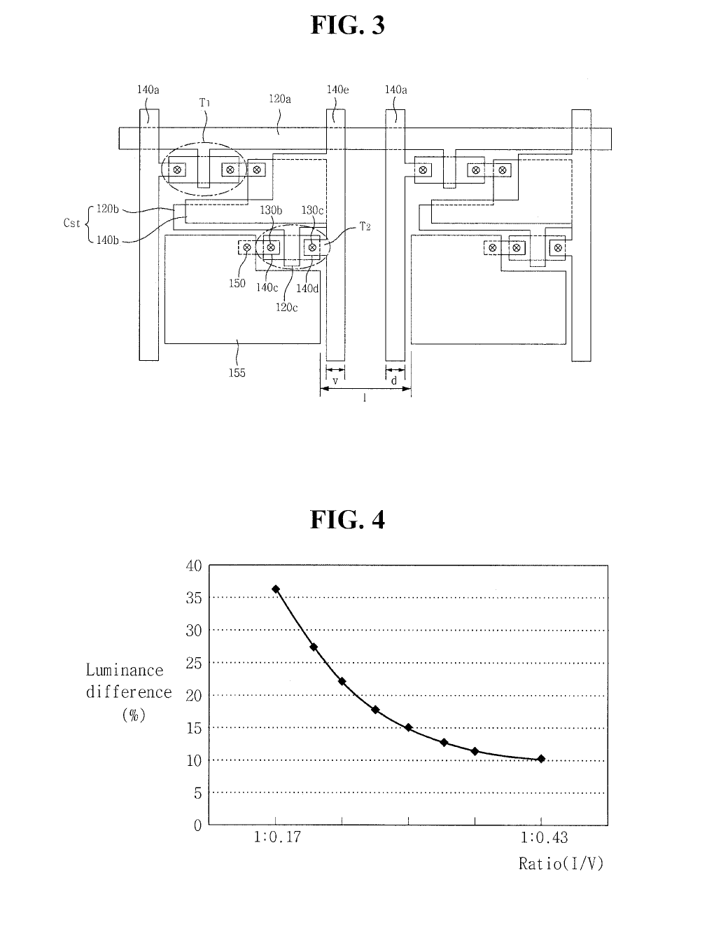

FIG. 3 shows an organic light emitting device according to another exemplary embodiment. The organic light emitting device illustrated in FIG. 3 is based on a plurality of sub-pixels. Structures and components identical or equivalent to those described in the previous two embodiments are designated with the same reference numerals, and therefore a description thereof is briefly made or is entirely omitted.

As shown in FIG. 3, a substrate (not shown) includes one or more sub-pixel areas and one or more non-sub-pixel areas outside respective ones of the sub-pixel areas. Each sub-pixel area is defined, for example, by a corresponding scan line 120a positioned in one direction, a corresponding data line 140a positioned perpendicular to the scan line 120a, and a corresponding power supply line 140e parallel to data line 140a.

A plurality of sub-pixels are positioned in respective ones of the sub-pixel areas. Each sub-pixel area may include a switching thin film transistor T1 connected to scan line 120a and data line 140a, a capacitor Cst connected to the switching thin film transistor T1 and power supply line 140e, and a driving thin film transistor T2 connected to capacitor Cst and the power supply line. The capacitor Cst may include a capacitor lower electrode 120b and a capacitor upper electrode 140a.

Each sub-pixel area may further include an organic light emitting diode, that includes a first electrode 155 electrically connected to driving thin film transistor T2, an organic layer (not shown) having at least an emitting layer on the first electrode, and a second electrode (not shown). The scan lines 120a, data lines 140a, and power supply lines 140e are positioned in respective non-sub-pixel areas.

As described above, each sub-pixel area, defined by a corresponding scan line, data line, and power supply line, may include a plurality of sub-pixels, and the scan lines 120a, data lines 140a, and power supply lines 140e are preferably positioned between the sub-pixels (i.e., in corresponding non-sub-pixel areas).

The non-sub-pixel area between the sub-pixels is generally considered to be an area where substantial light emission is not performed. When the emitting layer is deposited using a shadow mask, the non-sub-pixel area may be determined by conditions such as a margin of the shadow mask, a deposition shadow phenomenon, and/or a distance between the substrate and shadow mask. Further, the non-sub-pixel area may be determined by formation spaces of the data lines 140a and the power supply lines 140e.

Widths of data line 140a and power supply line 140e positioned in the non-sub-pixel area may be appropriately set. Also, a ratio (I/d) of a distance (I) between the sub-pixels to a width (d) of the data line 140a positioned between the sub-pixels may range from 1:0.1 to 1:0.29. When the ratio (I/d) is equal to or more than 1:0.1, a voltage drop based on a resistance of data line 140a can be prevented and thus distortion of a data signal can be prevented. When the ratio (I/d) is equal to or less than 1:0.29, pixel shrinkage can be prevented due to an increase in the width (d) of the data line 140a.

A ratio (I/v) of the distance (I) between the sub-pixels to a width (v) of the power supply line 140e positioned between the sub-pixels may range from 1:0.17 to 1:0.43. When the ratio (I/v) is equal to or more than 1:0.17, a voltage drop based on a resistance of power supply line 140e can be prevented and thus distortion of a power signal can be prevented. Hence, a light emission luminance of the device can be uniform. When the ratio (I/v) is equal to or less than 1:0.43, pixel shrinkage can be prevented due to an increase in the width (v) of the power supply line 140e.

In summary, distortion of the data signal and power signal based on data line 140a and power supply line 140e can be prevented by adjusting ratios I/d and I/v. Hence, the light emission luminance can be made uniform.

FIG. 4 is a graph showing a non-limiting, exemplary relationship between ratio (I/v) and a luminance difference between top emission and bottom emission in an organic light emitting device constructed in accordance with FIG. 3. As shown in FIG. 4, when ratio I/v is equal to or more than 1:0.17, the luminance difference between a top emission and a bottom emission in the organic light emitting device is reduced to equal to or less than 35%. When the ratio I/v is equal to or less than 1:0.43, the luminance difference is further reduced to 10%. An organic light emitting device according to another exemplary embodiment can reduce the luminance difference by setting the ratio (I/v) to be 1:0.17 to 1:0.43 and thus light emission luminance can be made uniform.

At least one embodiment therefore provides an organic light emitting device that is capable of obtaining uniform light emission luminance with improved reliability.

In one aspect, an organic light emitting device comprises a substrate including a pixel (or sub-pixel) area having a plurality of unit pixels (or unit sub-pixels) and a non-pixel (or non-sub-pixel) area, a scan line positioned in the non-pixel (or non-sub-pixel) area to supply a scan signal to the pixel (or sub-pixel) area, a data line positioned in the non-pixel area to supply a data signal to the pixel (or sub-pixel) area, and a power supply line positioned in the non-pixel (or non-sub-pixel) area to supply power to the pixel (or sub-pixel) area, wherein a ratio of a distance between the unit pixels (or unit sub-pixels) to a width of the power supply line substantially ranges from 1:0.17 to 1:0.43.

In another aspect, an organic light emitting device comprises a substrate including a non-pixel (or non-sub-pixel) area and a pixel (or sub-pixel) area including a plurality of unit pixels (or unit sub-pixels) which include a gate electrode, a gate insulating layer positioned on the gate electrode, a semiconductor layer positioned on the gate insulating layer, a source electrode and a drain electrode electrically connected to the semiconductor layer, a first electrode electrically connected to the drain electrode, an emitting layer positioned on the first electrode, and a second electrode positioned on the emitting layer, a scan line that is positioned in the non-pixel (or non-sub-pixel) area and supplies a scan signal to the pixel (or sub-pixel) area, a data line that is positioned in the non-pixel (or non-sub-pixel) area and supplies a data signal to the pixel (or sub-pixel) area, and a power supply line that is positioned in the non-pixel (or non-sub-pixel) area and supplies a power to the pixel (or sub-pixel) area, wherein a ratio of a distance between the unit pixels (or unit sub-pixels) to a width of the power supply line substantially ranges from 1:0.17 to 1:0.43.

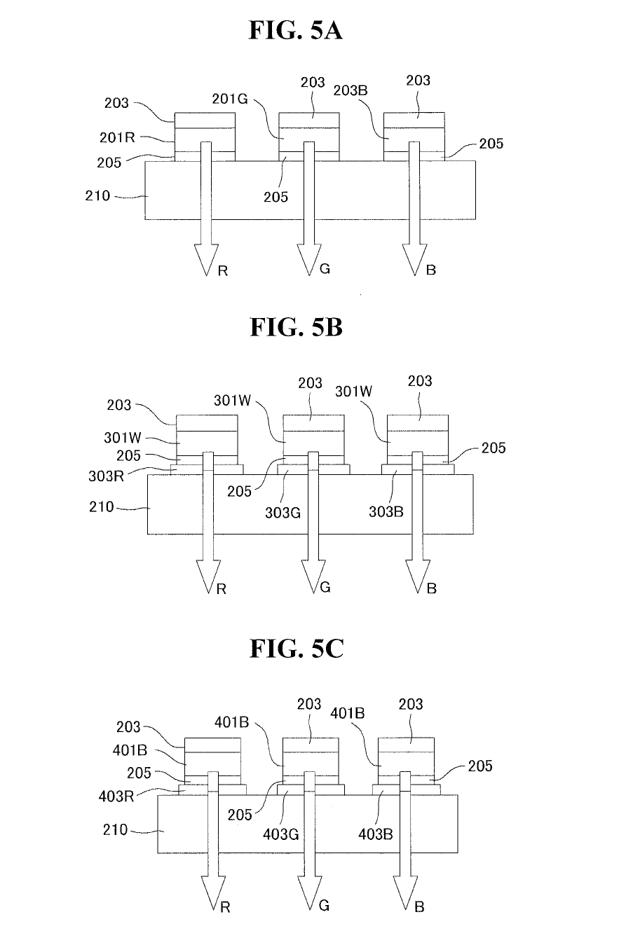

Additional embodiments relating to various color image display methods in an organic light emitting device will now be described with reference to FIGS. 5A to 5C.

FIGS. 5A to 5C illustrate various implementations of a color image display method in an organic light emitting device according to one exemplary embodiment.

First, FIG. 5A illustrates a color image display method in an organic light emitting device separately including a red organic emitting layer 201R, a green organic emitting layer 201G and a blue organic emitting layer 201B which emit red, green and blue light, respectively.

The red, green and blue light produced by the red, green and blue organic emitting layers 201R, 201G and 201B is mixed to display a color image.

It may be understood in FIG. 5A that the red, green and blue organic emitting layers 201R, 201G and 201B each include an electron transporting layer, an emitting layer, a hole transporting layer, and the like. In FIG. 5A, a reference numeral 203 indicates a cathode electrode, 205 an anode electrode, and 210 a substrate. It is possible to variously change a disposition and a configuration of the cathode electrode, the anode electrode and the substrate.

FIG. 5B illustrates a color image display method in an organic light emitting device including a white organic emitting layer 301W, a red color filter 303R, a green color filter 303G and a blue color filter 303B. And the organic light emitting device further may include a white color filter (not shown).

As illustrated in FIG. 5B, the red color filter 303R, the green color filter 303G and the blue color filter 303B each transmit white light produced by the white organic emitting layer 301W to produce red light, green light and blue light. The red, green and blue light is mixed to display a color image.

It may be understood in FIG. 5B that the white organic emitting layer 301W includes an electron transporting layer, an emitting layer, a hole transporting layer, and the like.

FIG. 5C illustrates a color image display method in an organic light emitting device including a blue organic emitting layer 401B, a red color change medium 403R and a green color change medium 403G.

As illustrated in FIG. 5C, the red color change medium 403R and the green color change medium 403G each transmit blue light produced by the blue organic emitting layer 401B to produce red light, green light and blue light. The red, green and blue light is mixed to display a color image.

It may be understood in FIG. 5C that the blue organic emitting layer 401B includes an electron transporting layer, an emitting layer, a hole transporting layer, and the like.

A difference between driving voltages, e.g., the power voltages VDD and Vss of the organic light emitting device may change depending on the size of the display panel 100 and a driving manner. A magnitude of the driving voltage is shown in the following Tables 1 and 2. Table 1 indicates a driving voltage magnitude in case of a digital driving manner, and Table 2 indicates a driving voltage magnitude in case of an analog driving manner.

TABLE 1

| Size (S) of | | | |
|---|---|---|---|
| display panel | VDD-Vss (R) | VDD-Vss (G) | VDD-Vss (B) |
| S < 3 inches | 3.5-10 (V) | 3.5-10 (V) | 3.5-12 (V) |
| 3 inches < S < 20 | 5-15 (V) | 5-15 (V) | 5-20 (V) |
| inches | | | |
| 20 inches < S | 5-20 (V) | 5-20 (V) | 5-25 (V) |

TABLE 2

| Size (S) of display panel | VDD-Vss (R, G, B) |
|---|---|
| S < 3 inches | 4~20 (V) |
| 3 inches < S < 20 inches | 5~25 (V) |
| 20 inches < S | 5~30 (V) |

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An organic light emitting device comprising:
a substrate having a plurality of pixels, each pixel comprising a plurality of sub-pixels, wherein each sub-pixel includes an emission area, the emission area including a first electrode, a second electrode and an emitting layer;
a plurality of scan lines, a scan line configured to provide a scan signal to a corresponding sub-pixel;
a plurality of data lines, a data line configured to supply data signal to a corresponding sub-pixel;
a plurality of power supply lines, a power supply line configured to provide power to a corresponding sub-pixel, wherein a ratio of a distance between adjacent sub-pixels to a width of the power supply line lies substantially in a range between 1:0.17 and 1:0.43.

2. The organic light emitting device of claim 1, wherein a width of each of the data line and the power supply line is larger than a width of the scan line.

3. The organic light emitting device of claim 1, wherein a resistance of the power supply line is lower than a resistance of the data line.

4. The organic light emitting device of claim 1, wherein a width of the power supply line is larger than a width of the data line.

5. The organic light emitting device of claim 1, wherein a resistance of the power supply line is lower than a resistance of the scan line.

6. The organic light emitting device of claim 1, wherein the data line and the power supply line have a single-layer structure or a multi-layer structure.

7. The organic light emitting device of claim 6, wherein the single-layer structure includes molybdenum (Mo), aluminum (Al), chromium (Cr), gold (Au), titanium (Ti), nickel (Ni), neodymium (Nd), or copper (Cu).

8. The organic light emitting device of claim 6, wherein the multi-layer structure has a triple-layer structure including Mo/Al/Mo or Mo/Al—Nd/Mo or Ti/Al/Ti.

9. The organic light emitting device of claim 1, wherein the scan line has a single-layer structure or a double-layer structure.

10. The organic light emitting device of claim 9, wherein the single-layer structure includes Mo, Al, Cr, Au, Ti, Ni, Nd, or Cu.

11. The organic light emitting device of claim 9, wherein the double-layer structure includes Mo/Al or Mo/Al—Nd or Ti/Al.

12. An organic light emitting device comprising:
a substrate having a plurality of pixels, each pixel comprising a plurality of sub-pixels, wherein each sub-pixel includes an emission area, the emission area including a first electrode, a second electrode and an emitting layer;
a plurality of scan lines, a scan line configured to provide a scan signal to a corresponding sub-pixel;
a plurality of data lines, a data line configured to supply data signal to a corresponding sub-pixel;
a plurality of power supply lines, a power supply line configured to provide power to a corresponding sub-pixel, wherein a ratio of a distance between adjacent sub-pixels to a width of the power supply line lies substantially in a range between 1:0.17 and 1:0.43, and wherein the emitting layer of at least one sub-pixel includes a phosphorescence material.

13. The organic light emitting device as recited in claim 12, wherein the emitting layer of at least one other sub-pixel includes a fluorescence material.

14. An organic light emitting device comprising:
a substrate having a plurality of pixels, each pixel comprising a plurality of sub-pixels, wherein each sub-pixel includes an emission area, the emission area including a first electrode, a second electrode and an emitting layer;
a plurality of scan lines, a scan line configured to provide a scan signal to a corresponding sub-pixel;
a plurality of data lines, a data line configured to supply data signal to a corresponding sub-pixel;
a plurality of power supply lines, a power supply line configured to provide power to a corresponding sub-pixel, wherein a ratio of the distance between adjacent sub-pixels to a width of the data line lies substantially in a range between 1:0.1 to 1:0.29.

15. The organic light emitting device of claim 14, wherein a width of each of the data line and the power supply line is larger than a width of the scan line.

16. The organic light emitting device of claim 14, wherein a resistance of the power supply line is lower than a resistance of the data line.

17. The organic light emitting device of claim 14, wherein a width of the power supply line is larger than a width of the data line.

18. The organic light emitting device of claim 14, wherein a resistance of the power supply line is lower than a resistance of the scan line.

19. The organic light emitting device of claim 14, wherein the data line and the power supply line have a single-layer structure or a multi-layer structure.

20. The organic light emitting device of claim 19, wherein the multi-layer structure has a triple-layer structure including Mo/Al/Mo or Mo/Al—Nd/Mo or Ti/Al/Ti.
